(19) United States
(12) Patent Application Publication
(10) Pub. No.: US 2008/0046239 A1
(43) Pub. Date: Feb. 21, 2008

(54) SPEECH-BASED FILE GUIDING METHOD AND APPARATUS FOR MOBILE TERMINAL

(75) Inventor: John BOO, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/837,244

(22) Filed: Aug. 10, 2007

(30) Foreign Application Priority Data
Aug. 16, 2006 (KR) 2006-0077042

(51) Int. Cl. G10L 15/26

(52) U.S. Cl. 704/235; 704/E15.044

(57) ABSTRACT

A speech-based file guiding apparatus and method for a mobile terminal capable of playing multimedia files is provided. The speech-based file guiding method includes checking if a music play mode is activated; checking whether a file selection signal is input, if the music play mode is activated; and outputting, audio sounds corresponding to file information on a selected file if a file selection signal is input. As a result, file information is provided as speech, and the user can use the mobile terminal in an eyes-free mode.

### PRIORITY

This application claims priority to an application entitled “SPEECH-BASED FILE GUIDING METHOD AND APPARATUS FOR MOBILE TERMINAL” filed in the Korean Intellectual Property Office on Aug. 16, 2006, and assigned Serial No. 2006-0077042, the contents of which are incorporated herein by reference.

### BACKGROUND OF THE INVENTION

1. Field of the Invention

The present invention relates generally to a mobile terminal and, more particularly, to a speech-based file guiding apparatus and method for a mobile terminal capable of playing multimedia files, wherein file information is provided as speech.

2. Description of the Related Art

Advances in information and communication technologies have enabled popularization of mobile terminals. In addition to conventional phone call processing, advanced mobile terminals support various data communication services. Using a mobile terminal, a user in motion can send and receive calls and short message service (SMS) messages at most times and places. Further, the user can connect to the Internet through wireless communication to receive on-demand multimedia-services.

Mobile terminals have recently added functional modules such as a camera module, music player, gaming module, global positioning system (GPS) receiver, and digital broadcast receiver, for more diverse features.

In particular, mobile terminals equipped with a music player became very popular for their entertainment functions in outdoor activities. A user in motion can enjoy music through a wired or wireless headset connected to a mobile terminal securely placed in a pocket or bag.

However, to utilize the different functions of the mobile terminal, for example, selecting a new music file, the user may have to take the mobile terminal out of the pocket or bag, and look at the small display screen of the mobile terminal. This interaction may interrupt ongoing activities and cause the user to be less attentive, leading to errors or accidents.

### SUMMARY OF THE INVENTION

The present invention has been made in view of the above problems, and the present invention provides a speech-based file guiding apparatus and method for a mobile terminal, wherein multimedia files can be conveniently manipulated using a text-to-speech (TTS) function.

The present invention also provides a speech-based file guiding apparatus and method for a mobile terminal, wherein file information is provided as speech.

In accordance with an exemplary embodiment of the present invention, there is provided a speech-based file guiding method for a mobile terminal, including checking whether a music play mode is activated; checking, if the music play mode is activated, whether a file selection signal is input; and if a file selection signal is input, outputting speech sounds corresponding to file information on a file selected according to the input file selection signal.

In accordance with another exemplary embodiment of the present invention, there is provided a speech-based file guiding method for a mobile terminal, including checking whether a music play mode is activated; checking, if the music play mode is activated, whether a file selection signal is input; if a file selection signal is input, converting file information on a music file selected according to the input file selection signal into speech; decoding music data of the selected music file into music; and outputting the audio sounds.

In accordance with another exemplary embodiment of the present invention, there is provided a speech-based file guiding apparatus for a mobile terminal, including a memory unit for storing music files; a control unit for selecting a music file from the memory unit, in response to a file selection signal; and a speech guiding module for converting file information on the selected music file into speech, and outputting the speech together with music of the selected music file.

### BRIEF DESCRIPTION OF THE DRAWINGS

The above and other objects, features and advantages of the present invention will be more apparent from the following detailed description in conjunction with the accompanying drawings, in which:

FIG. 1 illustrates use of a mobile terminal and a headset for music playing;

FIG. 2 illustrates a configuration of a mobile terminal having a speech-based file guiding function according to the present invention;

FIG. 3 illustrates a configuration of a multimedia module of the mobile terminal of FIG. 2; and

FIG. 4 is a flow chart of a speech-based file guiding method according to the present invention.

### DETAILED DESCRIPTION OF PREFERRED EMBODIMENTS

Hereinafter, exemplary embodiments of the present invention are described in detail with reference to the accompanying drawings. The same reference symbols identify the same or corresponding elements in the drawings. Detailed descriptions of constructions or processes known in the art may be omitted to avoid obscuring the invention in unnecessary detail. Particular terms may be defined to describe the invention in the best manner. The description of the various embodiments is to be construed as exemplary only and does not describe every possible instance of the invention. Therefore, it should be understood that various changes may be made and equivalents may be substituted for elements of the invention.

The mobile terminal of the present invention is a terminal having a music player, and may also have information and communication equipments or multimedia equipment, such as a mobile communication terminal, Personal Digital Assistant (PDA), smart phone, International Mobile Telecommunications 2000 (IMT 2000) terminal, Universal Mobile Telecommunications System (UMTS) terminal, digital broadcast receiving terminal, notebook, and personal computer.

For the purpose of description, the mobile terminal is assumed to communicate with a Bluetooth® headset. That is, the mobile terminal and the headset are Bluetooth-enabled devices.

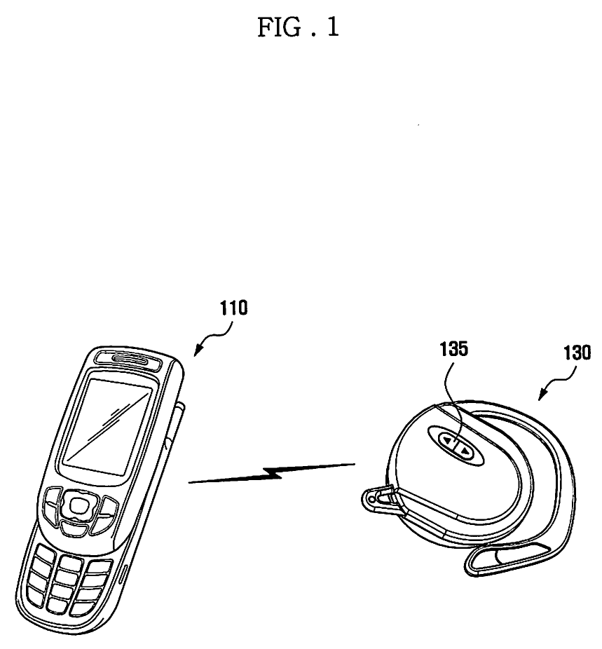

Referring to FIG. 1, mobile terminal 110 having a music player module (not shown) communicates with headset 130 through a Bluetooth® link. Headset 130 includes a remote control module 135 for generating a control signal to control the music player module of mobile terminal 110.

The music player module of mobile terminal 110 is remotely controlled according to a control signal that is generated and sent by remote control module 135 of headset 130. Mobile terminal 110 controls operations of the music player module on the basis of a control signal from remote control module 135 or a keypad unit (not shown). Mobile terminal 110 sends file information regarding a music file to be played by the music player module as a speech guide message to headset 130. The speech guide message contains information on the title, artist, and genre of the music file.

Upon reception of a speech guide message, headset 130 provides detailed information on the music file to the user by outputting the received speech guide message. Thereby, the user can select a desired music file with reference to the speech guide message. For example, the user can select a music file to be played through manipulation of remote control module 135 of headset 130.

Thereafter, mobile terminal 110 plays a music file indicated by a received music selection control signal, and the user listens to the corresponding music through headset 130.

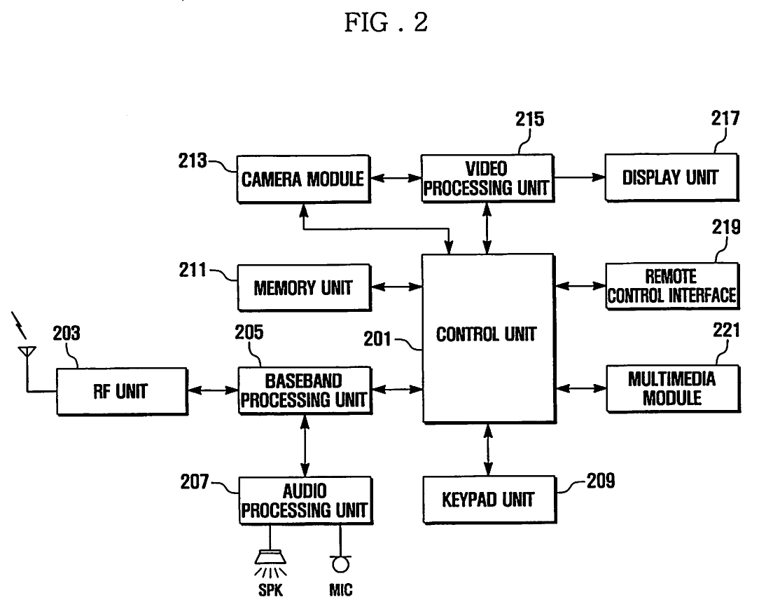

Referring to FIG. 2, the mobile terminal having a music playing function includes a control unit 201, radio frequency (RF) unit 203, baseband processing unit 205, audio processing unit 207, keypad unit 209, memory unit 211, camera module 213, video processing unit 215, display unit 217, remote control interface 219, and multimedia module 221.

Camera module 213 acts as a digital camera. Camera module 213 obtains a digital image of a target object, and sends the digital image to video processing unit 215.

Video processing unit 215 buffers and processes a digital image from camera module 213 using a display memory (not shown), and outputs the processed digital image to display unit 217 for display.

RF unit 203 includes an RF transmitter for transmitting an RF signal through an antenna, and an RF receiver for receiving an RF signal through the antenna. RF unit 203 is connected to baseband processing unit 205.

Baseband processing unit 205 converts a digital signal into an analog signal for transmission through the RF transmitter of RF unit 203. Baseband processing unit 205 also converts a baseband signal, which is obtained by reception and processing by the RF receiver of RF unit 203, into a digital signal for further processing by other elements of the mobile terminal.

Audio processing unit 207 converts an analog audio signal from a microphone MIC into a digital audio signal, and also converts a digital audio signal from baseband processing unit 205 into an analog audio signal for output through a speaker SPK.

Baseband processing unit 205 is connected to control unit 201. Control unit 201 controls the overall operation of the mobile terminal according to program instructions stored in memory unit 211. Baseband processing unit 205 is engaged in handling audio, signaling, and data processing operations related to data transmission through RF or Bluetooth® communication.

Keypad unit 209 includes a plurality of alphanumeric keys for inputting numeric and character data, and a plurality of function keys for inputting commands to set various functions and to control the mobile terminal.

Remote control interface 219 is a Bluetooth® module that defines a link layer and application layer according to the Bluetooth® specification. In the present embodiment, remote control interface 219 establishes a wireless channel to headset 130 for sending an audio signal and receiving a command signal. The connection between the mobile terminal and headset 130 may also be established through a wired or wireless channel other than a Bluetooth® channel.

Multimedia module 221 is a music player module, and finds a music file stored in a separate multimedia memory (not shown) and plays the found music file, in response to a command signal from keypad unit 209 or from headset 130. Music files may have various compressed audio file formats such as MPEG-1 Audio Layer 3 (MP3), and Windows Media Audio (WMA). Multimedia module 221 is not limited to a music player, and may also be a multimedia file player such as a moving image player.

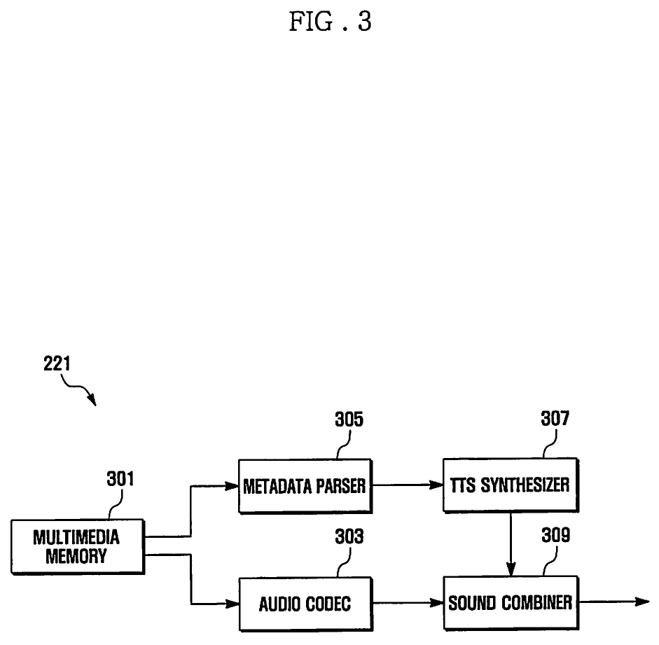

Referring to FIG. 3, multimedia module 221 includes a multimedia memory 301, audio Coder/Decoder (CODEC) 303, metadata parser 305, text-to-speech (TTS) synthesizer 307, and sound combiner 309.

Multimedia memory 301 stores digital music files downloaded from a Website or personal computer. Digital music files contain digital music data compressed in predefined audio formats. In response to a file selection signal input from keypad unit 209 or from headset 130 through a wireless channel, control unit 201 controls multimedia module 221 to find a desired music file, and to send the found music file to audio codec 303 and metadata parser 305.

Audio codec 303 decompresses music data of the music file. Metadata parser 305 extracts metadata from the music file, and sends the extracted metadata to TTS synthesizer 307. The metadata includes information on the title, artist, and genre of the music in the music file.

TTS synthesizer 307 synthesizes speech sounds corresponding to the metadata from metadata parser 305.

Sound combiner 309 combines the speech sounds from TTS synthesizer 307 and the music data from audio codec 303 together in a preset manner. That is, music and speech can be output simultaneously or separately. For example, speech introducing the music to be played are output first, and then the music in the music file is played.

Accordingly, the user can obtain information on a music file through speech sounds, and control the operation of multimedia module 221 on the basis of the obtained file information.

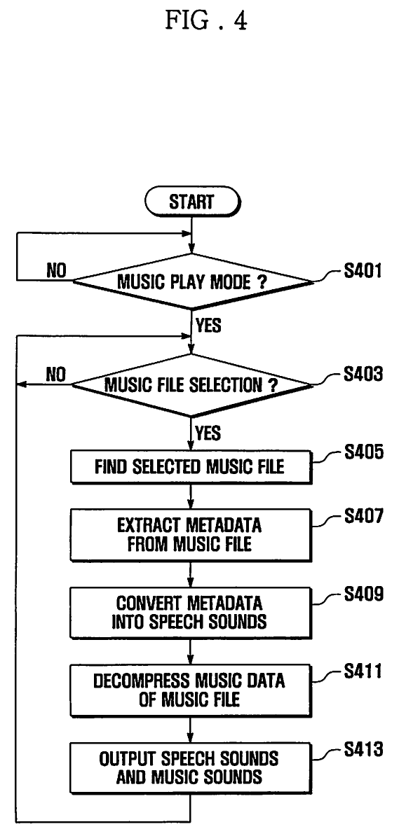

Referring to FIGS. 1 to 4, control unit 201 of the mobile terminal checks if the music play mode is activated in step S401. If the music play mode is activated, control unit 201 checks if a file selection signal is input in step S403. A file selection signal can be generated by a key of keypad unit 209 or by manipulation of remote control module 135 of headset 130.

If a file selection signal is input, control unit 201 finds a requested music file in multimedia memory 301 of multimedia module 221 in step S405.

Thereafter, control unit 201 controls metadata parser 305 of multimedia module 221 to extract metadata from the found music file in step S407, and controls TTS synthesizer 307 to synthesize speech sounds corresponding to the extracted metadata in step S409. The metadata includes information on the title, artist, and genre of the music in the music file.

Control unit 201 controls audio CODEC 303 of multimedia module 221 to decompress music data of the music file into music sounds in step S411.

Control unit 201 controls sound combiner 309 to combine the speech sounds from TTS synthesizer 307 and the music sounds from audio CODEC 303 together for output in step S413. That is, music sounds and speech sounds may be output simultaneously or separately. For example, speech sounds introducing the music to be played are output first, and then the music in the music file is played. Volumes of the music and speech can be adjusted manually or automatically at step S413.

As apparent from the above description, the present invention provides a speech-based file guiding apparatus and method for a mobile terminal, wherein file information is provided as speech. The user can use the mobile terminal in an eyes-free mode. In addition, the user can easily manipulate music file playing operations through a button of a headset connected to the mobile terminal.

While exemplary embodiments of the present invention have been shown and described in this specification, it will be understood by those skilled in the art that various changes or modifications of the embodiments are possible without departing from the spirit and scope of the invention as further defined by the appended claims.

What is claimed is:

1. A speech-based file guiding method for a mobile terminal, comprising:
checking if a music play mode is activated;
checking, if the music play mode is activated, whether a file selection signal is input; and
outputting audio sounds corresponding to file information on a file selected according to the input file selection signal if a file selection signal is input.

2. The speech-based file guiding method of claim 1, wherein the file is a music file.

3. The speech-based file guiding method of claim 2, wherein the file information comprises at least one of a title, artist, and genre of the selected music file.

4. The speech-based file guiding method of claim 2, wherein outputting audio sounds comprises:
finding a music file indicated by the input file selection signal;
extracting metadata from the found music file;
creating text information corresponding to the extracted metadata; and
converting the text information into audio sounds.

5. The speech-based file guiding method of claim 4, wherein the text information is converted into the audio sounds through text-to-speech synthesis.

6. The speech-based file guiding method of claim 5, wherein the text information comprises at least one of a title, artist, and genre of the selected music file.

7. A speech-based file guiding method for a mobile terminal, comprising:
checking if a music play mode is activated;
checking, if the music play mode is activated, whether a file selection signal is input;
converting file information on a music file selected according to the input file selection signal into audio sounds if a file selection signal is input;
decoding music data of the selected music file into audio sounds; and
outputting the audio sounds.

8. The speech-based file guiding method of claim 7, wherein the file information is metadata attached to the selected music file.

9. The speech-based file guiding method of claim 8, wherein the metadata comprises at least one of a title, artist, and genre of the selected music file.

10. The speech-based file guiding method of claim 7, wherein converting file information comprises:
extracting metadata from the music file;
creating text information corresponding to the extracted metadata; and
converting the text information into audio sounds.

11. The speech-based file guiding method of claim 7, wherein the speech and the music are output in sequence.

12. The speech-based file guiding method of claim 7, wherein the speech and the music are output simultaneously.

13. A speech-based file guiding apparatus for a mobile terminal, comprising:
a memory unit for storing music files;
a control unit for selecting, in response to a file selection signal, a music file from the memory unit; and
a speech guiding module for converting file information on the selected music file into speech, and outputting the speech together with music of the selected music file.

14. The speech-based file guiding apparatus of claim 13, wherein the speech guiding module comprises:
a coder/decoder (CODEC) for decoding music data of the selected music file into music; and
a speech generator for converting the file information into speech.

15. The speech-based file guiding apparatus of claim 14, wherein the speech generator comprises:
a metadata parser for extracting metadata from the selected music file; and
a speech synthesizer for converting the metadata into audio sounds.

16. The speech-based file guiding apparatus of claim 15, wherein the metadata comprises at least one of a title, artist, and genre of the selected music file.

17. The speech-based file guiding apparatus of claim 16, wherein the speech synthesizer is a text-to-speech synthesizer.

18. The speech-based file guiding apparatus of claim 16, wherein the speech and the music are output in sequence.

19. The speech-based file guiding apparatus of claim 16, wherein the speech and the music are output simultaneously.
